(19) United States
(12) Patent Application Publication
(10) Pub. No.: US 2019/0282421 A1
(43) Pub. Date: Sep. 19, 2019

(54) SYSTEM AND METHOD FOR CONTROLLING ACTUATORS IN AN OPERATING TABLE OR CEILING UNIT

(71) Applicant: MAQUET GMBH, Rastatt (DE)

(72) Inventors: Bapio BAMOUNI, Rheinstetten (DE); Markus BÜRSTNER, Karlsruhe (DE); Cedric KIEFFER, Strasburg (FR)

(73) Assignee: MAQUET GMBH, Rastatt (DE)

(21) Appl. No.: 16/421,419

(22) Filed: May 23, 2019

Related U.S. Application Data
(63) Continuation of application No. PCT/EP2017/008008, filed on Nov. 22, 2017.

(30) Foreign Application Priority Data
Nov. 28, 2016 (DE) 10 2016 122 939.3

(51) Int. Cl. A61G 13/02

(52) U.S. Cl. CPC A61G 13/02

(57) ABSTRACT

An operating table with a patient support surface, or a ceiling unit having one or more arms, includes at least one component which can be moved by an actuator. The devices include a user interface via which a user can input a command for moving the component to a user interface microcontroller. A control device can query data of the user interface microcontroller, authenticate it and, upon a successful authentication, to control the actuator in order to move the component in accordance with the command of the user. The control device can include a first microcontroller and a second microcontroller.

### RELATED APPLICATIONS

Benefit and priority of PCT/EP2017/080089 (filed Nov. 22, 2017), and German filing DE 10 2016 122 939.3 (filed Nov. 28, 2016) is claimed. Both are fully incorporated herein.

### BACKGROUND

The present disclosure relates to an operating table or a ceiling unit with at least one component which can be moved by an actuator, and to a method for controlling actuators in an operating table.

In medical devices such as, e.g., ceiling mounts or operating tables, mechanical components are customarily present which can be moved by an actuator as soon as the user makes a function command by a data input interface. However, an erroneous movement of these components represents a safety risk for a patient, or a user of the medical device. Therefore, the controlling of the actuators is usually designed to be redundant so that additional safety and control mechanisms can be realized.

The control system is realized electronically and comprises as a rule one or more microcontrollers for processing of function commands. Measures are taken from observations of risks so that the controlling of the actuators takes place without first errors. The safety against first errors is historically realized by hardware redundancies in the system. However, this increases the complexity and the manufacturing costs of the medical device since components and communication channels (bus) must be made multiply available, tested, built in, and checked on account of the redundancies.

US 2013/0069778 A1 describes a dialysis device with a safety feature for supporting and monitoring the patient.

US 2011/0166512 A1 relates to a manual device for injecting a drug.

One advantage of the present disclosure is to reduce the complexity and manufacturing costs of an operating table but still be able to ensure secure controlling of actuators of the operating table.

### SUMMARY OF THE DISCLOSURE

The above-cited problem is solved by operating tables, and methods as disclosed herein. The disclosure can also be used with other medical devices such as, for example, the ceiling mount of an operating room, the ceiling mount carrying medical lights, monitors, cables, and IV bags on one or more arms.

A medicinal device such as, for example, an operating table or a ceiling mount, comprises at least one component which can be moved by an actuator. Furthermore, the device comprises a user interface by which a user can input a command for moving the component to a user interface microcontroller and comprises a control device designed to query data of the user interface microcontroller. Therefore, the user interface microcontroller does not have to be constantly active but rather can be engaged upon the inputting of a command by the user while the control device can find out by a polling method whether the user interface microcontroller is active and whether it received a command from a user. Furthermore, the control device is designed to authenticate the data received from the user interface microcontroller and, upon successful authentication, to control the actuator in order to move the component in accordance with the command of the user. Therefore, it can be ensured that the actuators are only actuated when it was checked that the control device as well as the user interface microcontroller are functioning without errors.

According to some embodiments the control device can comprise a first and a second microcontroller, wherein the first microcontroller is designed to communicate with the user interface microcontroller, and wherein the second microcontroller is designed to communicate with the first microcontroller. Therefore, the second microcontroller does not require its own communication channel to the user interface microcontroller but rather the communication between the user interface and the control device can be controlled by the first microcontroller without collisions or competition occurring on the communication channel and without a second communication channel being required between the control device and the user interface.

The second microcontroller can be designed to transmit a safety query, challenge via the first microcontroller to the user interface microcontroller, and wherein the first microcontroller is designed to receive the answer, response to the safety query and to forward the answer to the second microcontroller. Therefore, a challenge-response process can be carried out between the second microcontroller and the user interface microcontroller without a direct communication channel existing between the second microcontroller and the user interface microcontroller. The first microcontroller merely forwards the challenge as well as the response without changing or evaluating them. Other data from the user interface microcontroller such as, e.g., movement commands, can either also be sent together with the response or can be sent independently of the authentication via the challenge-response method separately from the user interface microcontroller to the first microcontroller.

According to some embodiments the first microcontroller can be designed to transmit a movement command to the actuator. Furthermore, the second microcontroller can be designed to activate an energy supply of the actuator. Therefore, a movement of the component of the medical device by the actuator only takes place if the first as well as the second microcontroller have identified the data received from the user interface microcontroller as a valid movement command.

According to some embodiments the control device can query data from the user interface microcontroller at regular time intervals. As a result, the user interface microcontroller cannot actively transmit any data but rather the communication channel between the control device in the user interface microcontroller can be controlled and operated by the control device.

According to some embodiments a bus system can be provided between the control device and the user interface which system is designed in such a manner that the data exchange between all elements of the control device and the user interface runs over the bus system. Therefore, only one data line is needed between the control device and the user interface. This simplifies the construction of the medical device, in particular if the control device is arranged at a greater spatial distance from the user interface.

According to some embodiments the control device can be connected via two separate communication channels to a control of the actuator, wherein the energy supply for the actuator can be activated via a first communication channel and movement commands can be transmitted via a second communication channel to the actuator. Therefore, in a modular, medical device each module provided with at least one actuator can be provided with its own actuator control which can then be connected via the two communication channels to the central control device of the medical device. Alternatively, the control device can be designed to directly control the energy supply and the movement of the actuator.

According to some embodiments the user interface can be connected to an operating element, wherein the operating element is designed to generate a first signal with which an energy supply to the user interface microcontroller can be activated and to generate a second signal which corresponds to the command inputted by the user for moving the component of the medical device. Therefore, the user interface microcontroller is only activated if the operating element is actually activated by a user and a valid user input can be recognized in the operating element by an additional capacitive sensor for generating the first signal.

It can be provided that the operating element communicates with the user interface and that the user interface evaluates signals of the operating element and generates the first and the second signal from them. In this instance, for example, even a single pressing of a key of a user can be evaluated by the user interface in such a manner that a first signal is generated from this which activates an energy supply to the user interface microcontroller as well as a second signal is generated which can subsequently be evaluated by the activated user interface microcontroller as a movement command.

According to another aspect a method is made available for controlling an actuator for moving at least one component of a medical device, wherein the method comprises the receiving of a command for moving the component via a user interface to a user interface microcontroller and comprises the querying of data of the user interface microcontroller by a control device. The data queried by the user interface microcontroller is subsequently authenticated in the control device and the actuator is controlled in accordance with the command if the authentication is successful in the control device. Therefore, the component of the medical device is only moved if the control device has checked that a valid movement control was inputted by a user and that the user interface microcontroller is functioning without errors.

According to some embodiments, the authentication step can comprise the transmitting of a safety query challenge from a second microcontroller of the control device via a first microcontroller of the control device to the user interface microcontroller, the user control device generating an answer, the sending of the answer in response to the safety query together with a movement command from the user interface microcontroller to the first microcontroller, and can comprise the transmitting of the answer from the first microcontroller to the second microcontroller. The answer can be subsequently checked by the second microcontroller in order to authenticate the movement command. Therefore, the communication between the control device and the user interface microcontroller can run completely via the first microcontroller and a challenge-response can nevertheless be realized between the second microcontroller and the user interface microcontroller, in which the particular challenge and response is only forwarded by the first microcontroller without the first microcontroller further processing, evaluating or changing the corresponding data. The first microcontroller also preferably does not know the correct answer to the safety query of the second microcontroller so that in case of an error function of the user interface microcontroller an answer of the first microcontroller cannot be falsely authenticated in the second microcontroller.

The step of the controlling of the actuator can comprise the transmitting of a movement command to the actuator by the first microcontroller and the activation of an energy supply of the actuator by the second microcontroller. This ensures that the component of the medical device is only moved if both microcontrollers have verified the authenticity of the data received by the user interface microcontroller.

According to some embodiments the control device can query the data of the user interface microcontroller at regular time intervals and therefore realize a polling process.

### SHORT DESCRIPTION OF THE DRAWINGS

Exemplary embodiments of the present disclosure are described in the following with reference made to the attached drawings in which the same reference numerals designate the same or corresponding elements.

FIG. 1 shows an exemplary operating table with controllable components, in which the device and the method according to embodiments of the present disclosure can be used.

FIG. 2 shows an exemplary ceiling mount with controllable components, in which the device and the method according to embodiments of the present disclosure can be used.

FIG. 3 shows a schematic survey of a control device according to a first embodiment of the present disclosure.

FIG. 4 shows a schematic survey of a control device according to a second embodiment of the present disclosure.

FIG. 5 shows a flowchart of a control process according to an embodiment of the present disclosure.

### DETAILED DESCRIPTION

Exemplary embodiments of the present disclosure are described in the following description with reference made to the drawings. The drawings are not necessarily true to scale but rather only schematically illustrates the particular features.

It should be noted that the following described features and components can be combined with each other regardless of whether they were described in connection with a single embodiment. The combination of features in the particular embodiments serves only to illustrate the basic design and the functioning of the claimed device and of the claimed method. Features which are described in conjunction with an embodiment of the device according to the disclosure can also be used in conjunction with the claimed method and vice versa.

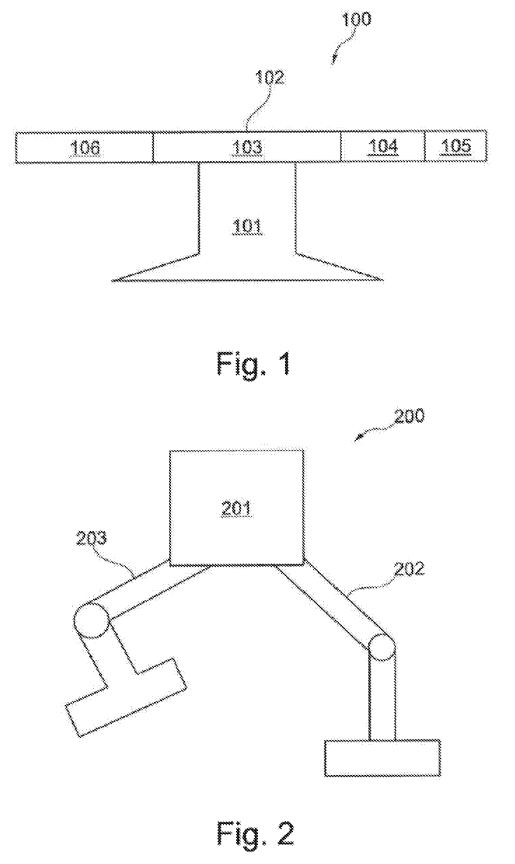

FIG. 1 schematically shows an operating table 100 with a foot 101 and a patient support surface 102. The patient support surface 102 comprises several components 103-106 such as, for example, back plates, head plates, leg plates and the like. The components 101, 103-106 can be moved by actuators in order to adjust the patient support surface 102 into a desired position. A user can input commands for controlling the actuators via an operating unit which is not shown.

FIG. 2 schematically shows a ceiling mount 200 in which several arms 202, 203 are attached to a central unit 201, which hold medical devices and can move into desired positions. The arms 202, 203 can be moved by actuators, wherein a user can control the movement of the arms 202, 203 by an operating unit which can be attached, for example, to the central unit 201.

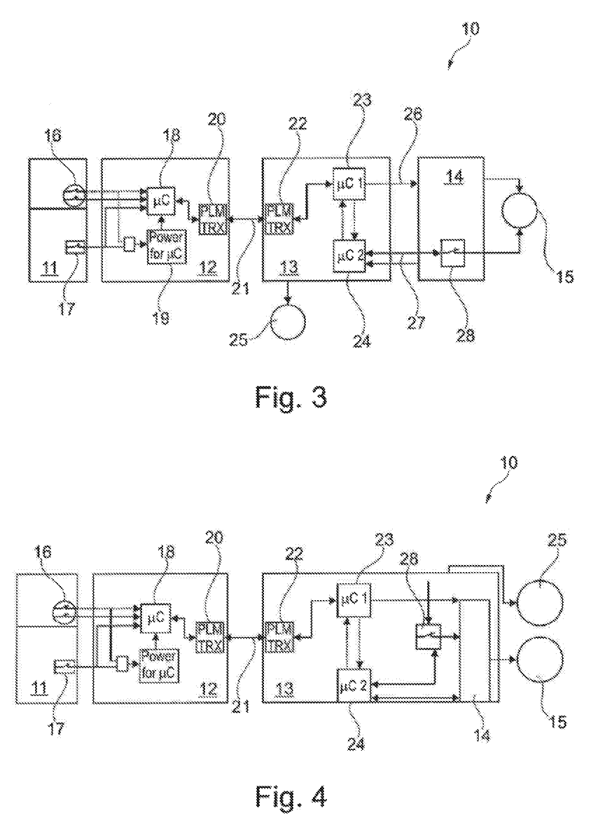

FIG. 3 shows a first embodiment of the device 10 according to the disclosure. In it a user interface 11 is connected to a user interface plate (UI processing board) 12 which is connected for its part to a control plate 13 and to a control 14. The control 14 makes available the voltage supply and the movement commands for at least one actuator 15 of a medical device such as, for example, an operation table 100 or a ceiling mount 200.

The user interface 11 can comprise here, for example, keyboards, membrane keyboards, touch screens, joysticks, levers, switches, and/or one or more membrane switches which on the one hand generate a first signal via a first contact which can be realized via a capacitive sensor 17, and wherein on the other hand the user can input a selection signal for a desired function via an operating element 16 such as, for example, via a key or a button. According to an embodiment the capacitive sensors 17 can comprise a switching membrane which is activated upon contact or pressure. Alternatively, a capacity sensor can be provided which is separately attached, comparable to a separate release switch. If the operating element 16 is designed as a membrane keyboard, each key can fulfill two functions, wherein the first signal can be produced by pressure on the membrane and the function can be selected via the corresponding key. The membrane signal on the membrane keyboard only indicates that the operating element 16 was actuated at all and does not show which key was actuated, i.e., which function a user selected.

Safety concept: if μC no longer has any current, it cannot send false commands.

The user interface plate 12 comprises a user interface microcontroller (μC) 18 which receives and processes the inputs of the operating element 16 and comprises a voltage supply 19 for the user interface microcontroller 18. The voltage supply 19 receives input signals from the capacitive sensor 17 and/or from the operating element 16 in order to supply the user interface microcontroller 18 with energy only when a user actuates the operating element 16 or the first contact 17.

The user interface plate 12 is connected to the control plate 13 by a data and energy supply line 21. Therefore, in the embodiment shown there is only one connection via a single bus system with appropriate interfaces 20, 22 between the user interface plate 12 and the control plate 13. Two other microcontrollers μC1 and μC2 are provided on the control plate 13 which are characterized in in FIG. 3 by the reference numerals 23 and 24. Only the first microcontroller (μC1) 23 is connected here to the bus system 20, 21, 22 and the second microcontroller (μC2) 24 communicates only indirectly via the first microcontroller 23 with the user interface plate 12. Furthermore, in the embodiment shown at least one brake 25 is present which blocks the manual adjusting of elements which are not driven by an actuator 15.

In the first embodiment shown in FIG. 3 the control 14 is provided separately from the control plate 13 and is connected via a first signal line 26 and a second current supply line 27 to the latter. The first microcontroller 23 can output commands via the signal line 26 to the at least one actuator 15. The current supply of the actuator 15 is again turned on and off via a switch 28 of the control 14, which switch is controlled by the second microcontroller 24. It can be provided here that the second microcontroller 24 monitors the function of the switch 28 and of the actuator 15 and transmits, if necessary, test signals to the switch 28 and/or to the actuator 15.

FIG. 4 shows a second embodiment of the device 10 according to the disclosure. The device 10 shown in FIG. 4 differs from the device shown in FIG. 3 in that the control 14 is integrated with the control plate 13. Here too, the at least one actuator 15 is controlled by the first microcontroller 23 and a current supply of the actuator 15 is activated or deactivated via a switch 28 by the second microcontroller 24.

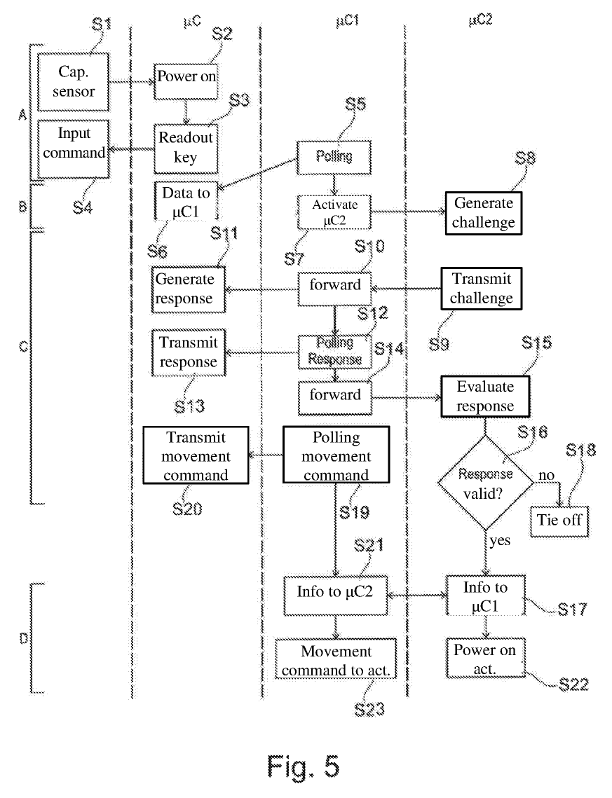

The function of the devices shown in FIGS. 3 and 4 is described in the following with reference made to FIG. 5.

FIG. 5 shows a schematic view of a method according to an embodiment. The method shown in FIG. 5 is divided into four aspects:
A. Data input
B. Processing
C. Receiving and converting
D. Generating movement.

These aspects are described in the following with reference made to the elements of the control device shown in FIGS. 3 and 4. Not all features are included in all embodiments.

A. Data Input

According to an embodiment an actuation of a user is received in step S1 in the user interface by a capacitive sensor or the like. This can be the actuation of a release key by the user or the contacting of the membrane of a membrane keyboard by the user. Then, in step S2 an energy supply to the user interface microcontroller 18 is turned on. The user interface microcontroller 18 then reads out in step S3 a movement command (step S4) inputted by the user via the user interface. The movement command can be, for example, a pressing down of a certain key of a membrane keyboard or the activation of a switch or the like for the selecting of a certain movement and direction of movement.

B. Processing

In certain embodiments, during processing the user interface microcontroller 18 does not transmit any commands from itself, but rather the first microcontroller 23 on the control plate 13 triggers each data transfer via the bus system 20, 21, 22 and cyclically queries data from the user interface microcontroller 18 (“polling” process, step S5). The first microcontroller 23 is preferably always active here, even if the user interface microcontroller 18 is turned off. The first microcontroller 23 preferably determines the times between the individual queries of a user interface plate 12. The times are in the millisecond range.

If the user interface microcontroller 18 is activated, and if a polling query of the first microcontroller 23 arrives, it can transmit an answer in step S6 to the polling query to the first microcontroller 23. This answer can already comprise the movement command inputted by the user, but may also be only a status indication of the user interface microcontroller 18.

C. Receiving and Converting

Upon the receiving and converting of the user commands queried by the first microcontroller 23, a second safety is provided by the second microcontroller 24 on the control plate 13. In the embodiment shown in FIG. 5 a challenge response method is used.

For this, the first microcontroller 23 can activate the second microcontroller 24 at first in step S7 which according to an embodiment therefore does not have to be permanently supplied with energy. Alternatively, it can also be provided that the second microcontroller 24 is permanently activated and only receives the command in step S7 to generate a challenge. In step S9 the second microcontroller 24 sends the challenge to the first microcontroller 23, which itself recognizes neither the challenge nor the associated correct response and therefore forwards the challenge in step S10 only to the user interface microcontroller 18.

In step S11 the user interface microcontroller 18 generates the correct answer, in response to the safety question challenge which was generated by the second microcontroller 24, and subsequently the first microcontroller 23 queries in step S12 the response via a polling process from the user interface microcontroller 18. In step S13 the user interface microcontroller 18 sends as answer to the query of the first microcontroller 23 the response to the first microcontroller 23, which cannot check the response itself and forwards it in step S14 unchanged to the second microcontroller 24.

The second microcontroller 24 checks the response in step S15 which the user interface microcontroller 18 generated. Upon a correct response, it is ensured that the user interface microcontroller 18 is turned on and is functioning. Therefore, if it is determined in step S16 that the response is valid, the second microcontroller 24 can inform the first microcontroller 23 in step S17 that the challenge-response process was successfully concluded and that the user interface microcontroller 18 is has been authenticated. If it is determined in step S16 that the response was not valid, the process is broken off in S18 and can be restarted, for example, by a new user input (step S1).

Parallel to the checking of the response by the second microcontroller 24, the first microcontroller 23 can query in step S19 a movement command from the user interface microcontroller 18 if the first microcontroller 23 did not already receive, for example, the movement command for the first query in step S5 or for the query of the response in step S12. In this case the user interface microcontroller 18 sends the movement command in step S20 to the corresponding query of the first microcontroller 23. The first microcontroller 23 can then check the movement command, for example, for at least one of plausibility and/or collision conditions or the like, and can inform the second microcontroller 24 in step S21 that there is a valid movement command.

The situation can occur in the above-described method in a so-called overrun that the user interface microcontroller 18 is still active even though the user is no longer pressing a button on the operating element. In this case the challenge-response process will still result in a correct response but the first microcontroller 1 will not receive a valid movement command. Therefore, during the reciprocal information exchange of the first and of the second microcontrollers 23, 24 in the steps S17 S21 it can be ensured that a movement is only generated if there is a valid movement command present as well as that it was insured that the user interface microcontroller 18 is authorized. The presence of a valid response alone does not directly lead here in the embodiment shown to the fact that, for example, the energy supply of the actuators is activated and the presence of a valid movement command by itself also does not directly lead to the fact that the latter is transmitted to the actuators. Therefore, it can also be ensured during the overrun time that the actuators are not falsely supplied with energy or are even moved on account of a possibly no longer current movement command if the user interface microcontroller 18 is still active but the user has no longer inputted any further command.

D. Generating Movement

Finally, in order to produce a movement of the actuators after the user interface microcontroller 18 has been authenticated and the movement command has been checked, the second microcontroller 24 activates in step S22 the energy supply of the actuator or of the actuators and the first microcontroller 23 forwards in step S23 the movement command to the control plate 14 from which the actuators 15 are controlled.

In the previously described method only a single user interface microcontroller 18 is used. However, even several different input devices can be provided which are designed as independent user interfaces and which each comprise a separate, associated user interface microcontroller 18. The above-described concept can also be scaled for such applications in which several user interface plates 12 are connected to the data bus of the control plate 13, since each individual user interface plate is only active as long as the user is operating it. The indirect data transfer between the second microcontroller 24 and the user interface microcontroller 18 via the first microcontroller 23 has the advantages that the bus 20, 21, 22 can be controlled and clocked by the first microcontroller 23 without other processors communicating via the same line. This simplifies the synchronization and the timing in the transfer of data since no competition or collision can occur.

Therefore, the above-described exemplary embodiments of the present disclosure ensure a secure controlling of actuators of the medical device even without the hardware components participating in the controlling of the actuator having to be designed to be completely redundant. It is in particular not required to provide a redundant communication line with appropriate redundant bus systems between a user interface and a control device since according to the previously described embodiments a challenge-response process can be realized even with a single data connection in order to check the error-free functioning of the user interface microcontroller 18 and of the first microcontroller 23 of the control plate 13 with a second microcontroller 24. Therefore, it can be ensured that the inputting of commands by the user as well as the outputting of movement commands by the first microcontroller 23 takes place without errors.

This devices, arrangements, and methods herein are also contemplated for use in controlling actuators in devices other than ceiling units and operating tables.

This disclosure contemplates all electronics, processors, circuitry, software, electronic instructions, digital memory, and the like necessary to implement the systems, methods, and devices described herein. The disclosure includes microcontrollers containing all processors, chip memory, electronics, electronic instructions, and the like to implement the corresponding systems and functions disclosed herein.

1. An operating table comprising:
a patient support surface which comprises a component which can be moved by an actuator;
a user interface via which a user can input a command for moving the component to a user interface microcontroller; and
a control device which is configured to query data of the user interface microcontroller, to authenticate it and, upon a successful authentication, to control the actuator in order to move the component in accordance with the command of the user.

2. The operating table according to claim 1, wherein the control device comprises a first microcontroller and a second microcontroller;
wherein the first microcontroller is configured to communicate with the user interface microcontroller, and
wherein the second microcontroller is configured to communicate with the first microcontroller, but not to communicate directly with the user interface microcontroller.

3. The operating table according to claim 2:
wherein the second microcontroller is configured to transmit a safety query challenge via the first microcontroller to the user interface microcontroller;
wherein the user interface microcontroller is configured to provide an answer in response to the safety query challenge; and
wherein the first microcontroller is configured to receive the answer from the user interface microcontroller, and to forward the answer to the second microcontroller.

4. The operating table according to one of claim 2:
wherein the first microcontroller is furthermore configured to transmit a movement command to the actuator; and
wherein the second microcontroller is furthermore configured to activate an energy supply of the actuator.

5. The operating table according to claim 1, wherein the control device queries data from the user interface microcontroller at regular time intervals.

6. The operating table according to claim 1, wherein a bus system is provided between the control device and the user interface, which system is configured in such a manner that the data exchange between all elements of the control device and the user interface runs over the bus system.

7. The operating table according to claim 1, wherein the control device is configured to separately control the energy supply and the movement of the actuator.

8. The operating table according to claim 1:
wherein the control device is connected via two separate communication channels to a control of the actuator; and
wherein the energy supply for the actuator can be activated via a first communication channel, and movement commands can be transmitted to the actuator via a second communication channel.

9. The operating table according to claim 1:
wherein the user interface is connected to an operating element,
wherein the operating element is configured to generate a first signal with which an energy supply to the user interface microcontroller can be activated, and to generate a second signal which corresponds to the command inputted by the user for moving the component of the operating table.

10. The operating table according to claim 9, wherein the operating element communicates with the user interface and wherein the user interface evaluates signals of the operating element and generates the first and the second signal from them.

11. A method for controlling an actuator for moving at least one component of a patient support surface of an operating table, comprising:
receiving a command for moving the component via a user interface to a user interface microcontroller;
querying data of the user interface microcontroller by a control device;
authenticating the data queried from the user interface microcontroller in the control device; and
controlling the actuator in accordance with the command only if the authentication is successful in the control device.

12. The method according to claim 11, wherein the authentication step comprises:
transmitting a safety query challenge from a second microcontroller of the control device via a first microcontroller of the control device to the user interface microcontroller;
providing an answer in response to the safety query challenge to the first microcontroller;
transmitting the answer from the first microcontroller to the second microcontroller; and
the second microcontroller checking the answer in order to authenticate the movement command.

13. The method according to claim 12, wherein the response together with a movement command is transmitted from the user interface microcontroller to the first microcontroller.

14. The method according to claim 12, wherein the step of the controlling of the actuator comprises:
transmitting a movement command to the actuator by the first microcontroller; and
activating an energy supply of the actuator by the second microcontroller.

15. The method according to claim 11, wherein the control device queries the data of the user interface microcontroller at regular time intervals.

16. A ceiling mount comprising:
a central unit;
an arm attached to the central unit, the arm being movable by an actuator;
a medical device held on the arm;
a user interface via which a user can input a command for moving the arm to a user interface microcontroller; and
a control device configured to query data of the user interface microcontroller, to authenticate it and, upon a successful authentication, to control the actuator in order to move the arm in accordance with the command of the user;
wherein the control device comprises a first microcontroller and a second microcontroller;
wherein the first microcontroller is configured to communicate with the user interface microcontroller, and
wherein the second microcontroller is configured to communicate with the first microcontroller, but is not configured to communicate directly with the user interface microcontroller.

17. The ceiling mount according to claim 16:
wherein the second microcontroller is configured to transmit a safety query challenge via the first microcontroller to the user interface microcontroller;
wherein the user interface microcontroller is configured to provide an answer to the safety query challenge; and
wherein the first microcontroller is configured to receive the answer to the safety query challenge, and to forward the answer to the second microcontroller.

18. The ceiling mount according to claim 16, comprising:
a plurality of arms attached to the central unit, the arms being movable by actuators; and
a plurality of medical devices held on respective arms.

19. The ceiling mount according to claim 16:
wherein the first microcontroller is configured to transmit a movement command to the actuator; and
wherein the second microcontroller is configured to activate an energy supply of the actuator.

20. The ceiling mount according to claim 16:
wherein the control device is connected via two separate communication channels to a control of the actuator; and
wherein an energy supply for the actuator can be activated via a first communication channel, and movement commands can be transmitted to the actuator via a second communication channel.
